(19) United States
(12) Patent Application Publication
(10) Pub. No.: US 2017/0368635 A1
(43) Pub. Date: Dec. 28, 2017

(54) OSCILLATING REMOTE LASER WELDING ON A FILLET LAP JOINT

(71) Applicants: Florian HANSCHMANN, Toronto (CA); Jonathan Michael CLAYTON, greenville, SC (US); Scott GARNER, Williamston, SC (US); MAGNA INTERNATIONAL INC., Aurora (CA)

(72) Inventors: Florian HANSCHMANN, Toronto (CA); Jonathan Michael CLAYTON, Greenville, SC (US); Scott GARNER, Williamston, SC (US)

(21) Appl. No.: 15/542,228

(22) PCT Filed: Jan. 20, 2016
(86) PCT No.: PCT/US2016/014000

§ 371 Date: Jul. 7, 2017

Related U.S. Application Data
(60) Provisional application No. 62/105,929, filed on Jan. 21, 2015.

(51) Int. Cl. B23K 26/082; B23K 26/242

(52) U.S. Cl. CPC B23K 26/082; B23K 26/242

(57) ABSTRACT

The invention provides an economical laser welding method for joining two metal materials with a fillet joint. The method reliably compensates for tolerances between the two materials and can be used in various light conditions and production environments. In addition, the method does not require additional equipment for purposes of seam tracking. Instead, the method includes oscillating a laser beam, for example in a “figure 8” pattern, while moving the laser beam laterally along an interface between the two materials. The width of the fillet joint is increased compared to the fillet joint that would be formed using a non-oscillating laser beam, and thus compensates for the tolerances. The width of the fillet joint depends on the oscillation amplitude of the laser beam, rather than the beam size.

### CROSS REFERENCE TO RELATED APPLICATION

This PCT Patent Application claims the benefit of and priority to U.S. Provisional Patent Application Ser. No. 62/105,929 filed Jan. 21, 2015, the entire disclosure of the application being considered part of the disclosure of this application, and hereby incorporated by reference.

### BACKGROUND OF THE INVENTION

### 1. Field of the Invention

The invention relates generally to laser welding techniques, and more particularly to laser welding a fillet joint between metal materials for automotive vehicle applications.

### 2. Related Art

Structural components for automotive vehicles oftentimes include a plurality of metal materials joined together with a laser weld. Laser welding includes applying a concentrated heat source in the form of a laser beam along an interface between the two materials. The laser beam melts a portion of both materials along the interface, and the melted materials solidify to form the joint. This technique provides a strong joint and can be conducted at high rates, which is desirable in the production of automotive vehicle components.

Various different types of joints can be formed by laser welding, including overlap joints and fillet joints. Fillet joints are oftentimes preferred because they allow for a lightweight product and stable zinc degassing, which provides good weld quality. However, high position accuracy, which is difficult to achieve, is oftentimes required due to the size of the tolerances along the interface between the metal materials. One technique currently used to form fillet joints with high position accuracy includes using a remote laser along with a three-dimensional camera and an optical system. The camera and optical system precisely track the location of the interface and account for tolerances between the materials. However, this technique is oftentimes not suitable for use in certain light conditions and production environments, and the equipment is expensive.

### SUMMARY OF THE INVENTION

The invention provides an improved method of joining two metal materials disposed at an angle relative to one another by laser welding. The laser welding step includes forming a fillet joint along an interface between the two materials by oscillating the laser beam as the laser beam moves laterally along the interface. The width of the fillet joint formed by the oscillating laser beam is greater than the width of the fillet joint that would be formed using a non-oscillating laser beam. The greater width of the fillet joint compensates for tolerances along the interface between the two materials without the expensive camera and optical system. In addition, the laser welding method provided by the invention is suitable for use in various light conditions and production environments.

The invention also provides a laser welding apparatus for joining two metal materials with a fillet joint. The apparatus provides a laser beam which oscillates as the laser beam moves laterally along an interface between the two materials.

The invention further provides a component for an automotive vehicle application including two metal materials and a fillet joint therebetween. The fillet joint is formed by laser welding with an oscillating laser beam to increase the width of the fillet joint and thus account for tolerances along the interface.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 illustrates a method of laser welding two materials according to an exemplary embodiment of the invention;

FIG. 1A is an enlarged cross-sectional view of a portion of FIG. 1 showing a laser beam in the process of forming a fillet joint between the two materials;

FIG. 2A is a list of laser welding parameters used in an exemplary laser welding method;

FIG. 2B includes laser welding parameters used in another exemplary laser welding method;

FIGS. 3A-3D are screen shots of an exemplary software program used to implement the laser welding parameters;

FIGS. 4A-4C are photographs of the fillet joint formed between the two materials according to an exemplary embodiment;

FIGS. 5A-5C are photographs of the fillet joint formed between the two materials according to an another exemplary embodiment;

FIGS. 6A-6D are photographs of the fillet joint formed between the two materials according to yet another exemplary embodiment;

FIGS. 7A-7D are photographs of the fillet joint formed between the two materials according to another exemplary embodiment;

FIG. 8 is a photograph of the fillet joint formed between the two materials according to another exemplary embodiment; and

FIGS. 9A-9C are photographs of a portion of a vehicle door including the fillet joint formed between two aluminum materials according to another exemplary embodiment.

### DESCRIPTION OF THE ENABLING EMBODIMENTS

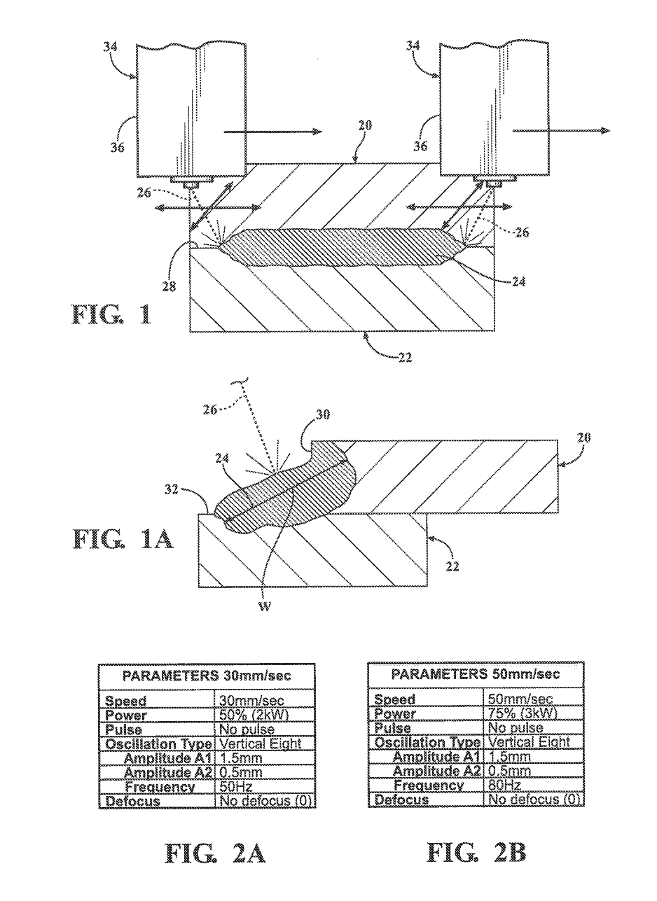

The invention provides an improved method for manufacturing metal components, especially those for use in automotive vehicle applications, including at least two metal materials 20, 22 joined together. An oscillating laser beam 26 is used to form a wide fillet joint 24, also referred to as a fillet lap joint or a weld seam. The increased width of the fillet joint 24 compensates for tolerances along an interface 28 between the two materials 20, 22. Thus, a reliable and strong fillet joint 24 can be formed in various light conditions and production environments. In addition, the fillet joint 24 is formed without the use of additional equipment, such as a three-dimensional camera and optical system for precise interface tracking. FIGS. 1 and 1A each show examples of the oscillating laser beam 26 joining the two materials 20, 22.

The method begins by providing the metal materials 20, 22 to be joined. Various materials 20, 22 can be joined using the method, and the materials 20, 22 can be the same or different from one another. In one embodiment, the materials 20, 22 include steel or another iron-based material, aluminum, or an aluminum alloy. For example, both materials 20, 22 can be formed of steel, both materials 20, 22 can be formed of aluminum, or one material can be formed of steel and the other aluminum. The size and shape of the materials 20, 22 to be joined depends on the desired application of the finished component. In the exemplary embodiments shown in the Figures, both materials 20, 22 are provided in the form of a sheet.

In preparation to form the fillet joint 24, the two materials 20, 22 are disposed at an angle relative to one another. In the exemplary embodiments, as best shown in FIG. 1A, a side surface 30 of the first material 20 is disposed at an angle, for example perpendicular, to a top surface 32 of the second material 22. However, the side surface 30 and top surface 32 could be disposed at other angles relative to one another. The two materials 20, 22 present the interface 28 at the intersection of the side surface 30 and the top surface 32, and the fillet joint 24 is formed along the interface 28.

As alluded to above, there are tolerances associated with the location of the interface 28 and/or the position of the materials 20, 22 relative to one another along the interface 28 that need to be accounted for during the laser welding process to ensure a strong fillet joint 24 is formed along the entire interface 28. For example, the location of the interface 28 may extend along a curved, bent, non-straight, or random path, rather than a straight line. The distance between the side surface 30 and the top surface 32 may also vary along the interface 28. These tolerances typically arise due to the various methods used to form the materials 20, 22. For example, when the side surface 30 of the first material 20 is trimmed to a desired shape, there are tolerances associated with the trimmed side surface 30.

Once the materials 20, 22 are provided and positioned at an angle relative to one another, the method includes laser welding the materials 20, 22 along the interface 28 to form the fillet joint 24 between the two materials 20, 22. In the exemplary embodiment, this step includes forming the fillet joint 24 between the side surface 30 of the first material 20 and the top surface 32 of the second material 22. However, the fillet joint 24 could be formed in other locations, depending on the shape of the materials 20, 22 to be joined.

As shown in FIG. 1, an apparatus 34 including a laser head 36 remote to the materials 20, 22 to be joined emits the oscillating laser beam 26. In the exemplary embodiment, the laser head 36 moves laterally along the interface 28 while emitting the laser beam 26 toward the materials 20, 22. Any type of laser capable of melting the metal materials 20, 22 can be used. The laser beam 26 melts a portion of the first material 20 and a portion of the second material 22 located along the interface 28, and the melted portions solidify to form the fillet joint 24. The size of the melted portions can vary depending on the size of the materials 20, 22.

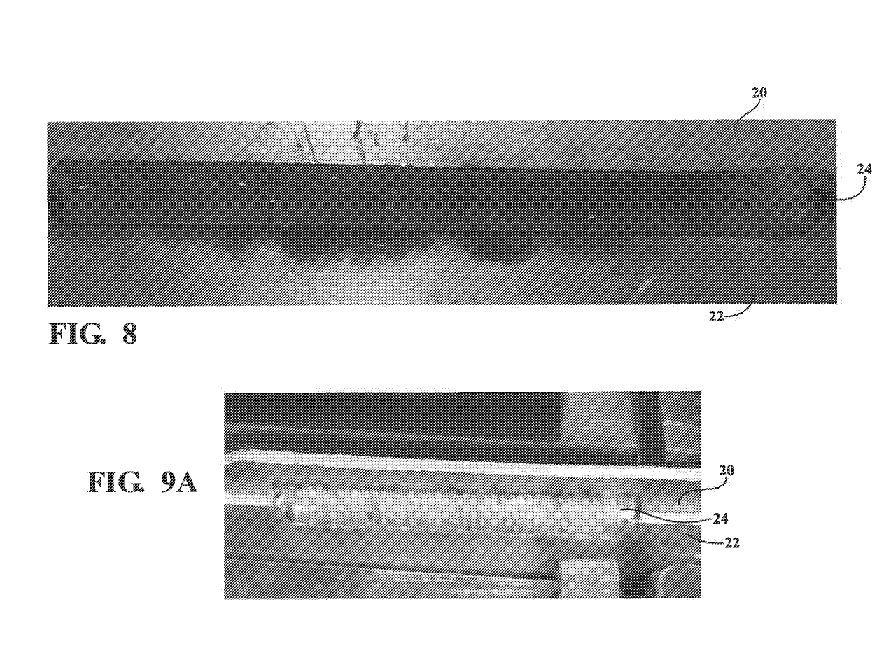

As stated above, the laser beam 26 continuously oscillates as it continuously moves laterally along the interface 28 in order to form the improved fillet joint 24, which is wider than the fillet joint that would be formed using a non-oscillating laser beam. The laser beam 26 moves continuously until the entire fillet joint 24 between the side surface 30 and the top surface 32. The wider fillet joint 24 provides a reliable and inexpensive way to compensate for the tolerances between the two materials 20, 22. The oscillating laser beam 26 emitted from the laser head 36 moves in at least two different directions while the laser head 36 moves laterally along the interface 28. In the exemplary embodiment shown in FIGS. 1 and 1A, the laser beam 26 oscillates in two directions along an x-axis. The laser beam 26 could alternatively oscillate along a y-axis and/or a z-axis, instead of or in addition to oscillating along the x-axis. The path along which the laser beam 26 oscillates can comprise various different patterns, designs, or figures. For example, the path of the oscillating laser beam 26 can be at an angle, for example perpendicular, relative to the interface 28 between the two materials 20, 22. In one embodiment, the laser beam oscillates in a “figure 8” pattern as the laser head 36 travels laterally along the interface 28. The oscillating laser beam 26 influences the melt pool dynamics and the heat affected zone of the materials 20, 22, which in turn contribute to the increased width w.

The width w of the fillet joint 24, which should be great enough to compensate for the tolerances between the two materials 20, 22, depends on the oscillation amplitude of the laser beam 26. This is unlike comparative fillet joints formed using a non-oscillating laser beam, wherein the width w of the fillet joint depends on the beam size alone. The oscillation amplitude is the total distance covered by the oscillating laser beam 26 relative to a single axis during one oscillation cycle. For example, if the laser beam 26 oscillates by repeatedly moving 0.5 mm in one direction along an x-axis and then 0.5 mm in an opposite direction along the x-axis, the oscillation amplitude is 1.0 mm. The oscillation amplitude is typically predetermined prior to the laser welding process and depends on the size and shape of the materials 20, 22, as well as the size of the tolerances between the materials 20, 22. If there are significant variations in the interface 28, or in the location of the side surface 30 of the first material 20 relative to the top surface 32 of the second material 22, then the oscillation amplitude should be set to a relatively high value. If there are minor variations in the interface 28 or location of the side surface 30 of the first material 20 relative to the top surface 32 of the second material 22, then a lower oscillation amplitude should be set. In the exemplary embodiment of FIG. 1, the oscillation amplitude is set to compensate for trim edge tolerances of +/−0.5 mm.

In certain embodiments, the method employs a plurality of oscillation amplitudes when forming the fillet joint 24 between the two materials 20, 22. For example, the oscillating laser beam 26 can oscillate relative to both the x-axis and the y-axis as the laser head 36 moves laterally along the interface 28 between the materials 20, 22. For example, when the laser beam oscillates according to the “figure 8” pattern, a first oscillation amplitude refers to movement of the laser beam 26 relative to the x-axis, and a second oscillation amplitude refers to movement of the laser beam 26 relative to the y-axis.

The method can also employ different oscillation amplitudes along different portions of the interface 28 between the materials 20, 22. For example, if greater tolerances are located along one portion of the interface 28, a greater oscillation amplitude is used along that portion of the interface 28, while a lower oscillation amplitude is used along another portion of the interface 28. The laser beam 26 can switch from one oscillation amplitude to another as the laser head 36 continuously moves laterally along the interface 28. The oscillation amplitude can also be set or adjusted while the laser head 36 moves laterally along the interface 28.

The method further includes setting other laser welding parameters, in addition to the oscillation amplitude, prior to or during the welding process. The other parameters typically include welding speed, energy or power level provided to the laser, pulse or no pulse, oscillation type figure or pattern, frequency of the oscillation figure, and defocus or no defocus. The welding speed is the speed at which the laser head 36 moves laterally along the interface 28. The power parameter typically includes the percentage of available power used during the welding process. The pulse parameter can be activated when it is desirable to repeatedly turn the laser beam 26 on and off, for example to reduce the amount of heat applied to the materials 20, 22. The oscillation type refers to the figure or pattern along which the laser beam 26 travels as the laser head 36 moves laterally along the interface 28. For example, the laser beam 26 can move in two opposite directions relative to the x-axis and/or the y-axis. In one embodiment, the laser beam 26 travels in a “figure 8” pattern relative to the x-axis and or the y-axis. The frequency parameter refers to the number of oscillation figures per minute, for example the number of “figure 8” patterns per minute. The method typically includes applying a focused laser beam 26. However, the defocus parameter can be activated when it is desirable to move the materials 20, 22 closer to the laser head 36, or move the laser head 36 closer to the materials 20, 22, for example to increase the size of the laser beam 26.

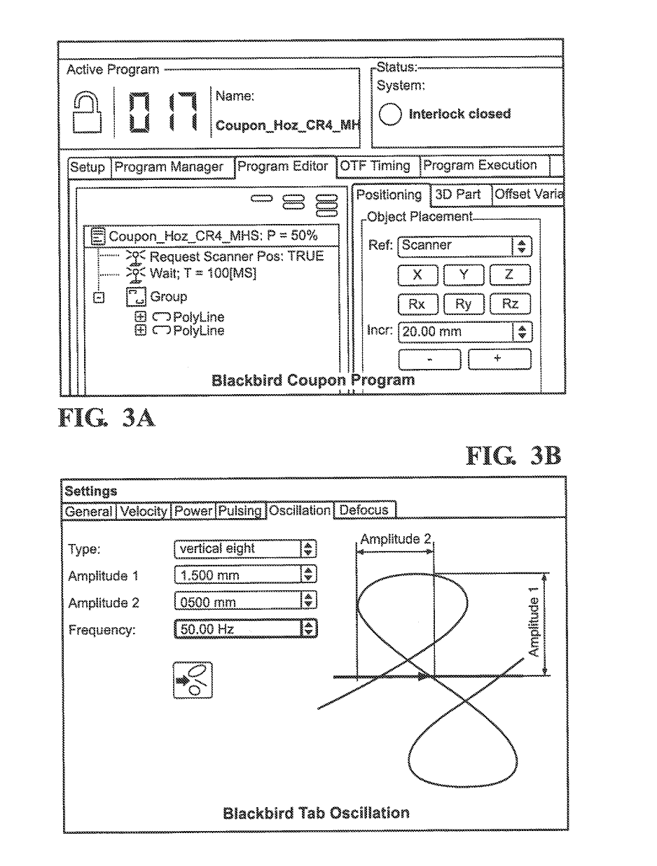

FIG. 2A illustrates the laser welding parameters for an exemplary method which includes oscillating the laser beam 26 according to the “figure 8” pattern. The method employs a first oscillation amplitude of 1.5 mm, which is the total distance covered by the laser beam 26 in the x-direction during one oscillation cycle, and a second oscillation amplitude of 0.5 mm, which is the total distance covered by the laser beam 26 in the y-direction during one oscillation cycle. In this embodiment, the welding speed is set to 30 mm/second, the power is set to 50% (2 kW), the pulse parameter is not activated, the frequency of the oscillation figure is 50 Hz, and the defocus parameter is not activated.

FIG. 2B illustrates laser welding parameters for another exemplary method which includes oscillating the laser beam 26 according to the “figure 8” pattern, wherein the first oscillation amplitude is 1.5 mm and the second oscillation amplitude is 0.5 mm. In this embodiment, the welding speed is set to 50 mm/second, the power is set to 75% (3 kW), the pulse parameter is not activated, the frequency of the oscillation figure is 80 Hz, and the defocus parameter is not activated.

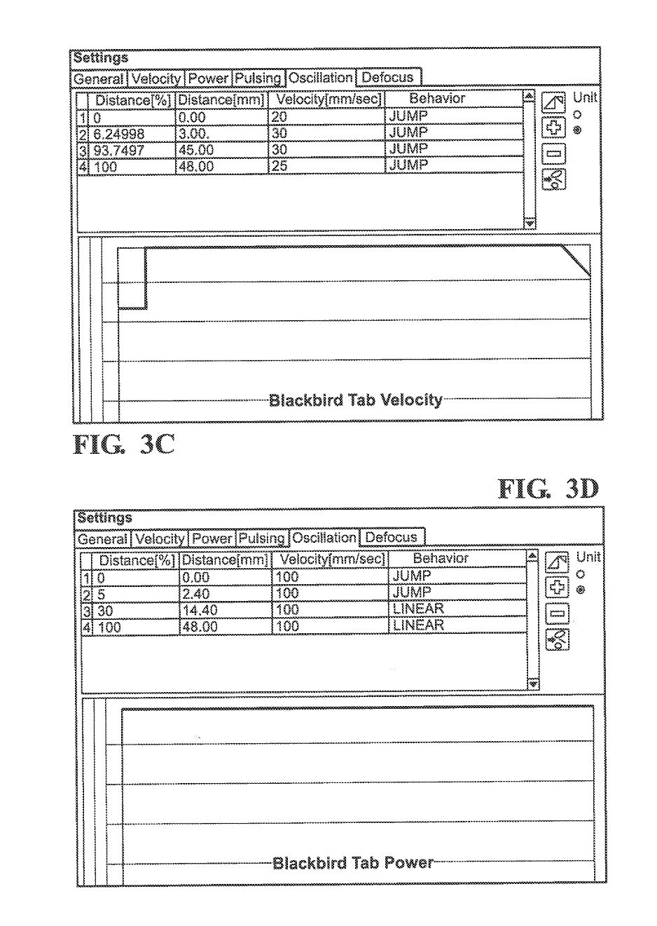

FIGS. 3A-3D includes screen shots of an exemplary computer software program which can be used to implement the welding parameters. In the embodiment of FIGS. 3A-3D, the oscillation figure type is the “figure 8” pattern described above.

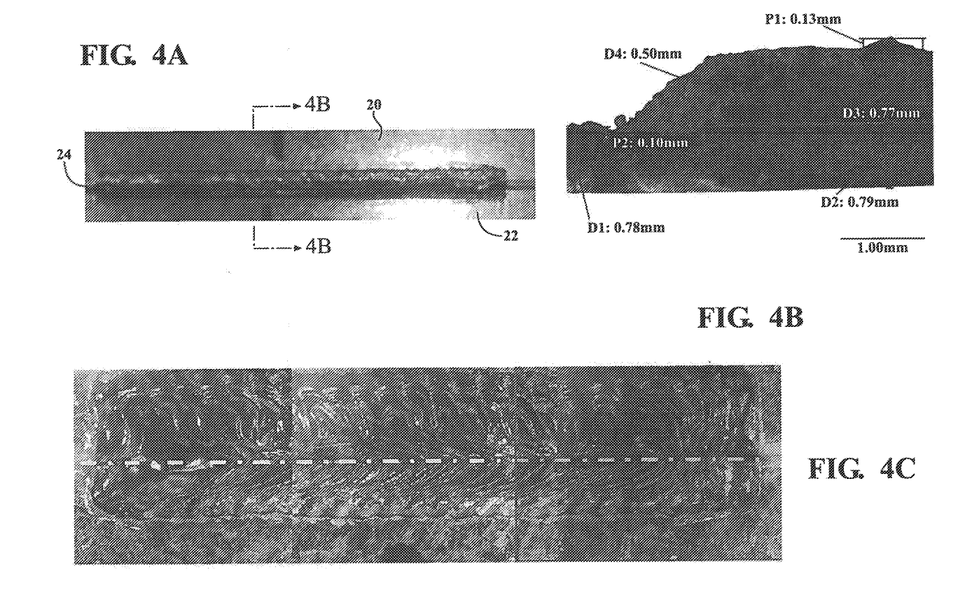

FIGS. 4A-9C are photographs showing materials 20, 22 joined together with the fillet joint 24 formed according to the method of the invention. FIG. 4A shows an example of the fillet joint 24 formed between the first material 20 and the second material 22 when welding speed is 50 mm/second and when the side surface 30 (trim edge) of the first material 20 is centered at 0 mm. FIG. 4B is a cross-sectional view of the fillet joint 24 of FIG. 4A along line B-B; and FIG. 4C is a magnified view of the fillet joint 24 of FIG. 4A.

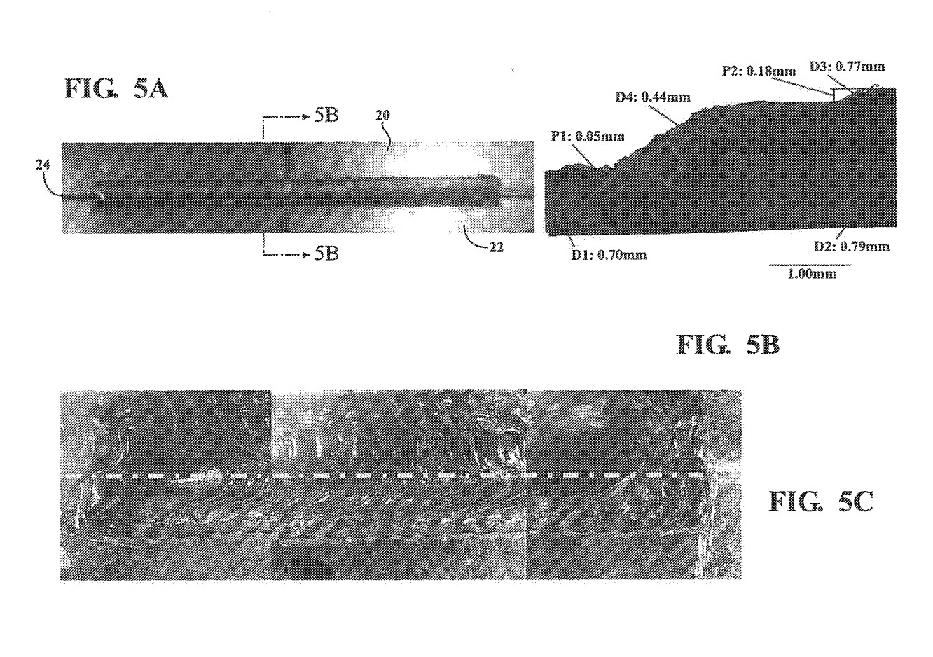

FIG. 5A shows another example of the fillet joint 24 formed between the first material 20 and the second material 22 when the welding speed is 50 mm/second and when the side surface 30 (trim edge) of the first material 20 is centered at 0 mm. FIG. 5B is a cross-sectional view of the fillet joint 24 of FIG. 5A along line B-B; and FIG. 5C is a magnified view of the fillet joint 24 of FIG. 5A.

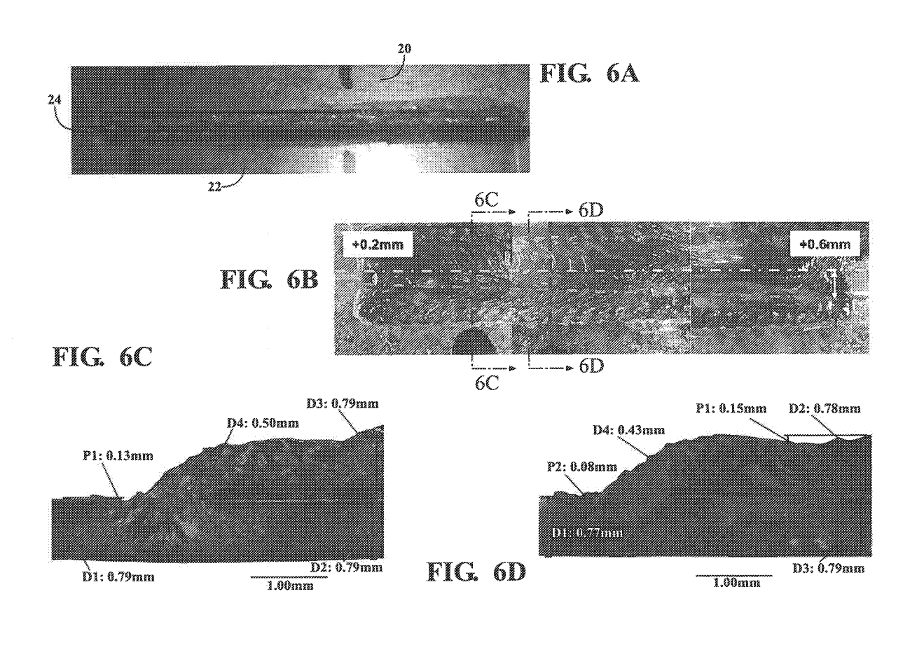

FIG. 6A shows another example of the fillet joint 24 formed between the first material 20 and the second material 22 when the welding speed is 50 mm/second and the side surface 30 (trim edge) of the first material 20 is spaced up to +0.6 mm from the centered position. FIG. 6B is a magnified view of the fillet joint 24 of FIG. 6A. FIG. 6C is a cross-sectional view of the fillet joint 24 of FIG. 6B along line C-C, wherein an oscillation amplitude of 0.5 mm compensates for a tolerance of +0.3 mm. FIG. 6D is a cross-sectional view of the fillet joint 24 of FIG. 6B along line D-D, wherein an oscillation amplitude of 0.5 mm compensates for a tolerance of +0.5 mm. It was concluded that welding parameters used to weld the fillet joint 24 of FIGS. 6A-6D adequately compensate for a trim edge tolerance of up to +0.5 mm.

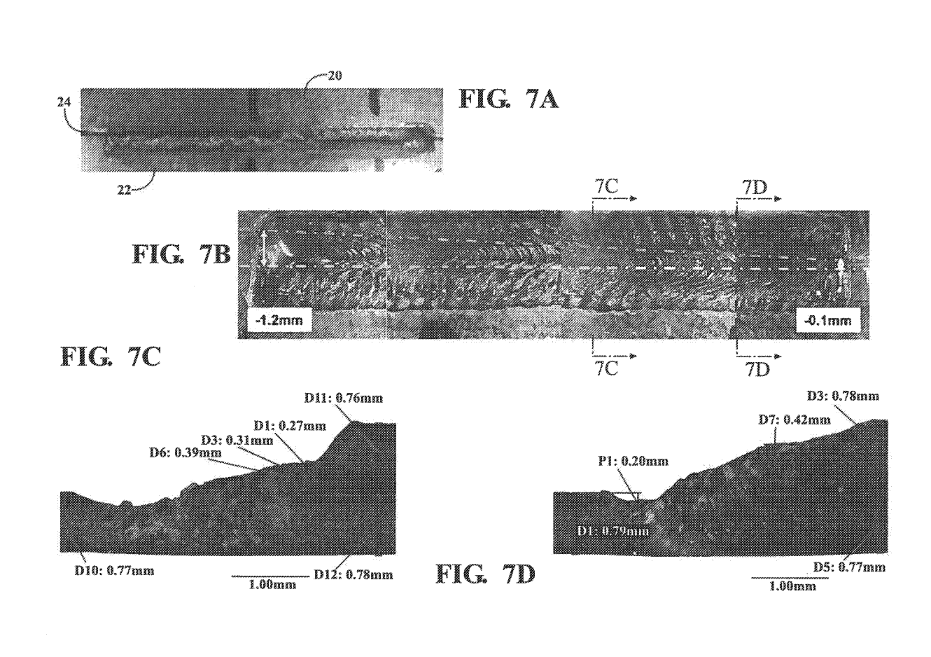

FIG. 7A shows another example of the fillet joint 24 formed between the first material 20 and the second material 22 when the welding speed is 50 mm/second and the side surface 30 (trim edge) of the first material 20 is spaced from up to −1.2 mm from the centered position. FIG. 7B is a magnified view of the fillet joint 24 of FIG. 7A. FIG. 7C is a cross-sectional view of the fillet joint 24 of FIG. 7B along line C-C, wherein an oscillation amplitude of 0.27 mm does not compensate for a tolerance of −1.0 mm. FIG. 7D is a cross-sectional view of the fillet joint 24 of FIG. 7B along line D-D, wherein an oscillation amplitude of 0.42 mm compensates for a tolerance of −0.3 mm. It was concluded that welding parameters used to weld the fillet joint 24 of FIGS. 7A-7D adequately compensate for a trim edge tolerance of up to −0.5 mm.

FIG. 8 is a photograph of the fillet joint 24 formed between the first and second materials 20, 22 according to another embodiment, wherein the welding parameters used to form the fillet joint 24 include a welding speed of 40 mm/second, power level of 3.8 kW, and oscillation frequency of 50 Hz.

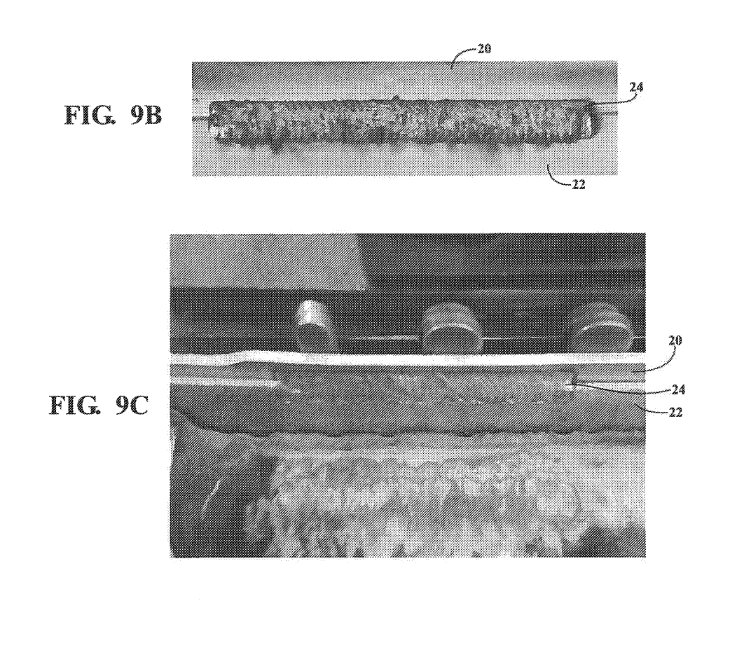

FIGS. 9A-9C are photographs of a portion of an example door for use in an automotive vehicle including the fillet joint 24 between the first and second materials 20, 22. The fillet joint 24 is again formed using the oscillating laser beam 26 described above. The first and second materials 20, 22 are formed of 5182 aluminum and each has a thickness of 1.5 mm.

Obviously, many modifications and variations of the present invention are possible in light of the above teachings and may be practiced otherwise than as specifically described while within the scope of the following claims.

1. A method of joining two materials, comprising the steps of:
welding a side surface of a first material to a top surface of a second material with a laser beam; and
the welding step including oscillating the laser beam while moving the laser beam laterally along an interface between the side surface of the first material and the top surface of the second material.

2. The method of claim 1, wherein the oscillating step includes moving the laser beam in at least two different directions.

3. The method of claim 2, wherein the oscillating step includes moving the laser beam along at least two of a x-axis, a y-axis, and a z-axis.

4. The method of claim 3, wherein the oscillating step includes moving the laser beam along the x-axis and the y-axis.

5. The method of claim 1, wherein the oscillating step includes moving the laser beam at an angle relative to the interface between the first material and the second material.

6. The method of claim 1 including the step of changing an oscillation amplitude of the laser beam while moving the laser beam laterally along the interface between the first material and the second material.

7. The method of claim 1, wherein the oscillating step includes moving the laser beam in a “figure 8” pattern while moving the laser beam laterally along the interface between the first material and the second material.

8. The method of claim 1, wherein the welding step includes continuously oscillating the laser beam while continuously moving the laser beam laterally along the interface to form a fillet joint between the side surface of the first material and the top surface of the second material.

9. The method of claim 1, wherein at least a portion of the interface between the first material and the second material is curved or bent.

10. The method of claim 1, wherein the distance between the first material and the second material varies along the interface between the side surface of the first material and the top surface of the second material.

11. The method of claim 1, wherein each material is steel, an iron-based material, aluminum, or an aluminum alloy.

12. The method of claim 1 including the step of trimming at least one of the materials to form the respective surface before the welding step.

13. The method of claim 12, wherein each material is steel, an iron-based material, aluminum, or an aluminum alloy; at least a portion of the interface between the first material and the second material is curved or bent; the distance between the first material and the second material varies along the interface between the side surface of the first material and the top surface of the second material; at least a portion of the interface between the first material and the second material is curved or bent; the side surface of the first material and the top surface of the second material are disposed at an angle relative to one another;
the oscillating step includes moving the laser beam at an angle relative to the interface between the first material and the second material;
the oscillating step includes moving the laser beam along a x-axis and a y-axis, and an oscillation amplitude of the laser beam along the x-axis is different from an oscillation amplitude of the laser beam along the y-axis;
the oscillating step includes changing at least one of the oscillation amplitudes of the laser beam while moving the laser beam laterally along the interface between the first material and the second material; and
the welding step includes continuously oscillating the laser beam while continuously moving the laser beam laterally along the interface to form a fillet joint between the side surface of the first material and the top surface of the second material.

14. A component for an automotive vehicle including a first material and a second material joined according to a process comprising the steps of:
welding a side surface of the first material to a top surface of the second material with a laser beam; and
the welding step including oscillating the laser beam while moving the laser beam laterally along an interface between the side surface of the first material and the top surface of the second material.

15. A laser welding apparatus including a laser beam for joining a first material to a second material according to a process comprising the steps of:
welding a side surface of the first material to a top surface of the second material with a laser beam; and
the welding step including oscillating the laser beam while moving the laser beam laterally along an interface between the side surface of the first material and the top surface of the second material.

16. The method of claim 4, wherein an oscillation amplitude of the laser beam along an x-axis is different from an oscillation amplitude of the laser beam along a y-axis.

17. The method of claim 1, wherein the welding step includes forming a fillet joint between the side surface of the first material and the top surface of the second material, the fillet joint has a width, and the width of the fillet joint depends on an oscillation amplitude of the laser beam.

18. The method of claim 12, wherein an oscillation amplitude of the laser beam is set to compensate for trim edge tolerances of +/−0.5 mm.

19. The method of claim 1 including setting laser welding parameters of the laser beam prior to the welding step, the laser welding parameters including oscillation amplitude, welding speed, energy or power level provided to the laser beam, pulse or no pulse, oscillation type figure or pattern, frequency of oscillation figure, and defocus or no defocus.

20. The component of claim 14, wherein the component is a portion of a door.
